(19) United States
(12) Patent Application Publication
(10) Pub. No.: US 2019/0042351 A1
(43) Pub. Date: Feb. 7, 2019

(54) SELF-HEALING IN A COMPUTING SYSTEM USING EMBEDDED NON-VOLATILE MEMORY

(71) Applicant: Intel Corporation, Santa Clara, CA (US)

(72) Inventors: Christopher CONNOR, Hillsboro, OR (US); Bruce QUERBACH, Hillsboro, OR (US)

(21) Appl. No.: 15/943,594

(22) Filed: Apr. 2, 2018

(51) Int. Cl. G06F 11/07; G06F 9/4401

(52) U.S. Cl. CPC G06F 11/0793; G06F 9/4405; G06F 11/0724

(57) ABSTRACT

Examples include techniques for self-healing of a processor in a computing system. A processor semiconductor chip includes one or more processing cores and an embedded non-volatile random-access memory (NVRAM), the NVRAM storing instructions that when executed by the one or more processing cores detect an error causing a core failure, update processor configuration information that reflects the core failure, and cause reset and initialization of the processor using the updated processor configuration information.

### TECHNICAL FIELD

Examples described herein are generally related to techniques for handling errors in a processor using an embedded non-volatile memory.

### BACKGROUND

Some computing systems include processors having multiple processing cores. in some processors, the number of processing cores may be large. During operation of the computing system, one or more of the processing cores may fail due to a hardware error that cannot be overcome or corrected. In some cases, the failure of a processing core leads to a failure of the entire multi-core processor, such that the multi-core processor needs to be replaced. In the case of a server, replacement of the multi-core processor results in significant downtime for a server blade, for example, which may house the multi-core processor, since a technician must physically remove the server blade, take the server blade to a repair location, replace the multi-core processor, and return the server blade to its former socket in the server. This downtime may be unacceptable in some processing environments, such as large server centers, which desire to offer a high level of service to customers.

### BRIEF DESCRIPTION OF THE DRAWINGS

FIG. 1 illustrates an example multi-core processor semiconductor chip having an embedded non-volatile random-access memory (NVRAM).

FIG. 2 illustrates an example of a logic flow that uses embedded NVRAM to perform self-healing of a multi-core processor semiconductor chip in a computing system.

FIG. 3 illustrates an example computing system that can perform processor self-healing using embedded NVRAM on a multi-core processor semiconductor chip.

FIG. 4 illustrates an example storage medium.

### DETAILED DESCRIPTION

As contemplated in the present disclosure, self-healing of a multi-core processor semiconductor chip may be performed by executing instructions of a self-healing component stored in an embedded NVRAM on the processing semiconductor chip. The self-healing component may be executed when an unrecoverable error is detected for a core of the multi-core processing. The self-healing component may analyze processor configuration information stored in the NVRAM at time of manufacture of the processor semiconductor chip to determine how to reconfigure the processor configuration for continued operation. The amended processor configuration information may be updated in the NVRAM by the self-healing component. In an embodiment, the self-healing component may remove a failed core from a set of valid and operable cores of the processor semiconductor chip. In an embodiment, the self-healing component may add a spare core to the set of valid and operable cores of the processor semiconductor chip, if there is a spare core.

Booting of a computing system may be performed by storing a basic input/output system (BIOS) firmware architecture, such as Unified Extensible Firmware Interface (UEFI) BIOS, in an embedded NVRAM on the processor semiconductor chip. Since the BIOS is located on-die within the processor semiconductor chip and may securely access component configuration information stored therein, efficiencies in booting and subsequent operation may be obtained over existing computing systems.

A BIOS is a computer program that initializes a computing system and loads an operating system (OS) for the computing system after completion of the power-on self-test (POST) actions. Within the hard reboot process, the BIOS runs after completion of the self-tests. In embodiments of the present invention, the BIOS is loaded into main memory from a persistent memory, such as an embedded NVRAM. The BIOS then loads and executes the processes that finalize the boot of the computing system. Like POST processes, the BIOS code comes from a “hard-wired” and persistent location; in this case a particular address in the embedded NVRAM. The BIOS acts as an interface between computer hardware and the OS. The BIOS includes instructions to initialize and enable low-level hardware services of the computing system, such as basic keyboard, video, disk drive, I/O ports, and memory controllers.

The initialization and configuration of the computing system by the BIOS occurs during a pre-boot phase. After system reset, the processor refers to a predetermined address which is mapped to the NVRAM in the processor semiconductor chip storing the BIOS (i.e., on-die). The processor sequentially fetches BIOS instructions from the NVRAM. These instructions cause the computing system to initialize its computing hardware, initialize its peripheral devices, and boot the OS.

Once the computing system is running, a self-healing component may manage the current set of valid and operable cores. In one embodiment, the self-healing component may be a part of the BIOS. In other embodiments, the self-healing component may be separate from the BIOS, but also stored in the embedded NVRAM along with processor configuration information.

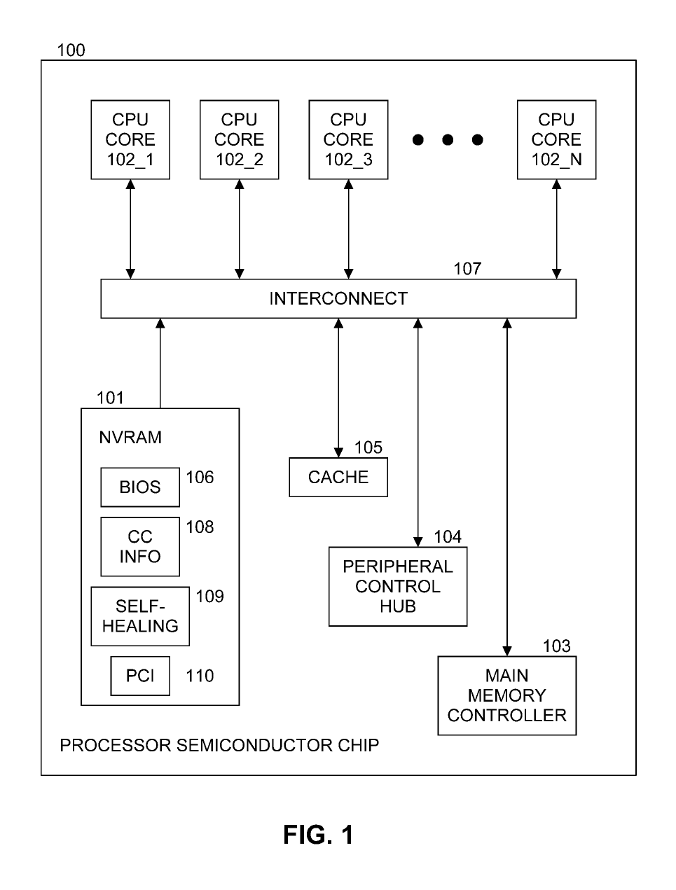

FIG. 1 illustrates an example processor having an embedded non-volatile random-access memory (NVRAM). FIG. 1 shows an improved approach in which processor semiconductor chip 100 includes an embedded non-volatile memory that is used to store information and instructions of BIOS 106 that executes on processor 100. In an embodiment, the non-volatile memory may be an embedded NVRAM 101, and BIOS 106 includes instructions for managing the boot-up process of a computing system. In embodiments, BIOS 106 may comply with UEFI specification version 2.7A, dated September 2017 or other later versions as disclosed at www.uefi.org. NVRAM 101 may include component configuration information (CC Info) 108 describing components installed in a computing system. In an embodiment, CC Info 108 may include the serial numbers of memory devices (e.g., DIMMs) installed in a system memory of the computing system. In other embodiments, other identifying information for memory devices or peripheral devices may be included in CC Info 108.

NVRAM 101 may also include self-healing component 109. Self-healing component 109 includes instructions to manage a set of valid and operable cores within processor semiconductor chip 100. NVRAM 101 may also include processor configuration information (PCI) 110. Processor configuration information 110 may include information identifying a set of valid and operable cores, a set of failed cores, and a set of spare cores. Initially, at time of manufacture of the processor semiconductor chip, the set of valid and operable cores may be set to a predetermined first number, the set of failed cores may be empty, and the set of spare cores may be set to a predetermined second number. The sum of the number of valid and operable cores, failed cores, and spare cores may equal the number of cores physically present in the processor semiconductor chip. PCI 110 may be used by one or more of self-healing component 109, BIOS 106, the OS, or other system software to update the sets of valid and operable cores, failed cores, and spare cores.

Here, as is known in the art, a processor semiconductor chip includes other components supporting a complete computing system. For example, as seen in FIG. 1, processor semiconductor chip 100 includes a number of central processing unit (CPU) processing cores 102_1 through 102_N (which execute program code instructions), coupled via an interconnect 107 to one or more of a main memory controller 103 (to interface to the computing system's main memory), a peripheral control hub 104 (to interface with peripherals of the computing system (e.g., a display, a keyboard, a printer, non-volatile mass storage, network interfaces (such as an Ethernet interface and/or wireless network interface), etc.), cache 105, and possibly a special purpose processor (such as a graphics processing unit (GPU) and/or a digital signal processor (DSP), not depicted in FIG. 1) to offload specialized and/or numerically intensive computations from the CPU cores.

In embodiments of the present invention, processor semiconductor chip 100 of FIG. 1 includes embedded NVRAM 101. NVRAM 101 may be one or more of emerging non-volatile memory technologies such as Ferroelectric random-access memory (FeRAM), dielectric random-access memory, resistive random-access memory (ReRAM), Memristor random access memory, phase-change random access memory, three-dimensional cross-point random access memory (such as 3D XPoint™ commercially available from Intel Corporation), magnetic random-access memory (MRAM), and spin-torque transfer magnetic random-access memory (STT-MRAM). In one embodiment, NVRAM 101 is a three-dimensional cross-point RAM.

A number of these technologies can be integrated into a high-density logic circuit manufacturing process such as a manufacturing process used to manufacture a processor semiconductor chip 100 as depicted in FIG. 1. For instance, the storage cells of an emerging non-volatile memory may store different resistive states (e.g., the cell exhibits a higher resistance or a lower resistance depending on whether it has been programmed with a 1 or a 0) and reside in the metallurgy of the semiconductor chip above the semiconductor substrate.

Here, for instance, a storage cell may reside between orthogonally directed metal wires and a three-dimensional cross-point structure may be realized by stacking cells and their associated orthogonal wiring in the semiconductor chip's metallurgy. Additionally, the access granularities may be much finer grained than traditional non-volatile storage (which traditionally accesses data only in large sector or block-based accesses). That is, an emerging non-volatile memory may be designed to act as a true random-access memory that can support data accesses at byte level granularity or some modest multiple thereof per address value that is applied to the memory.

Notably, because of the locality of NVRAM 101 on-die, the time to access BIOS 106 and/or self-healing component 109 and the time to persist any data (such as component configuration information (CC Info) 108 and/or processor configuration information (PCI) 110) read by or written by the BIOS and/or the self-healing component are dramatically reduced as compared to approaches that keep BIOS and/or self-healing component and the persisted data off the processor semiconductor chip, such as in a EEPROM or flash memory, and accessible via peripheral control hub 104 and associated components and interfaces.

In various embodiments, the address space of the embedded NVRAM 101 is (at least partially) reserved for the use of the BIOS and/or the self-healing component. That is, the embedded NVRAM 101 may be regarded as a special memory resource, e.g., different than main memory (which is external from processor semiconductor chip 100 and coupled to main memory controller 203) that the BIOS and/or the self-healing component understands it has permission to access in order to read/write its particular data structures.

Thus, in various embodiments, the instruction set architecture of one or more of the processor's CPU cores 102 includes special memory access instructions that target the embedded NVRAM 101 rather than main memory or other memory. As such, in various embodiments, the BIOS and/or the self-healing component may execute at least some of its respective instructions primarily out of main memory (e.g., the program code instructions may be transferred from NVRAM 101 into main memory) but program code of the BIOS and/or the self-healing component to access NVRAM 101 for at least some of its data may include a special read instruction that targets the embedded NVRAM 101. In further embodiments, BIOS 106 and/or self-healing component 109 are able to write to NVRAM 101 in order to update/persist any such data with another special write instruction that targets the embedded NVRAM 101.

Here, the special nature of a memory access instruction that targets the embedded NVRAM 101 can be designed into the instruction format of the instruction set architecture of the processor's CPU cores 102 with a special opcode or immediate operand that specifies memory access is to be directed to embedded NVRAM 101 rather than main memory. Alternatively, the address space of NVRAM 101 can be viewed as a privileged region of main memory address space. In this case, the NVRAM 101 can be accessed with a nominal memory access instruction but the BIOS and/or the self-healing component has to be given special privileged status to access it.

According to various embodiments, BIOS 106, component configuration information (CC Info) 108, self-healing component 109, and processor configuration information (PCI) 110 may be programmed directly into the embedded NVRAM 101 as part of the processor semiconductor chip manufacturing process. As such, each time the processor's computing system boots up, the computing system does not need to access the BIOS or off-die self-healing code from a flash memory or other mass storage, all of which are typically accessed over a peripheral control hub or other slower interface. Since self-healing component 109 comprises instructions to be executed by one or more cores, is not hardwired into the circuitry of the processor semiconductor chip, and processor configuration information may be programmatically updated, embodiments of the present invention provide more flexibility in managing cores.

With processor 100 having embedded (on-die) NVRAM 101, a more architecturally compact solution may thus be realized for BIOS 106 and/or self-healing component 109.

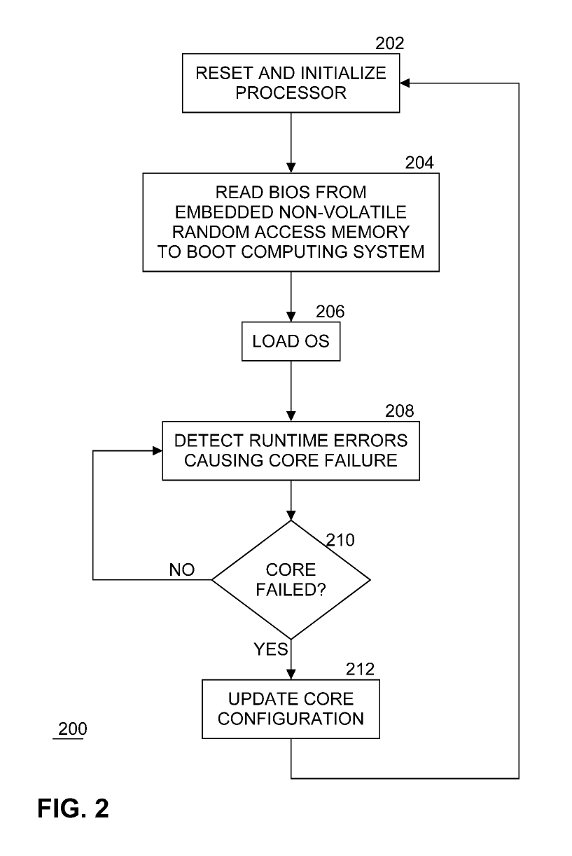

FIG. 2 illustrates an example of a logic flow that uses embedded NVRAM. In some examples, the process as shown in FIG. 2 depicts a process to implement self-healing of a processor in a computing system. For these examples, this process may be implemented by or use components or elements of processor 100 shown in FIG. 1. However, this process is not limited to being implemented by or use only these components or elements of system 100.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

Turning now to FIG. 2, processing begins at block 202. At block 202, processor semiconductor chip 100 may be reset and initialized. At block 204, BIOS 106 instructions and/or data may be read from NVRAM 101 and executed by one or more of the CPU cores 102_1, 102_2, 102_3, to 102_N. In embodiments, BIOS 106 may perform computing system initialization steps as described in UEFI specification version 2.7A, dated September 2017 or other later versions as disclosed at www.uefi.org. At the time of manufacturing a computing system including the processor semiconductor chip, a computing system manufacturer may obtain the serial number or other identifying information uniquely identifying each system memory device (such as a DIMM) and store this information as CC Info 108 into NVRAM 101 using BIOS 106. Whenever thereafter system memory is changed, such as when an additional DIMM is added or swapped out for a new one by an end user, the memory information in CC Info 108 may be updated by BIOS 106. In another embodiment, information about system components other than memory devices may also be stored in NVRAM 101.

In an embodiment, at the time of manufacturing the processor semiconductor chip, possibly during validation testing, information describing the valid and operable cores present in the processor semiconductor chip may be stored in processor configuration information (PCI) 110 in NVRAM 101. In an embodiment, PCI 110 may include information identifying a set of valid and operable cores, a set of failed cores, and a set of cores held in reserve as spares. In an embodiment, the set of failed cores initially includes cores, if any, that did not pass validation testing after manufacturing. In an embodiment, the set of failed cores may initially be null. As part of the booting process, the BIOS may use the processor configuration information, specifically the set of valid and operable cores, in initializing the computing system. At block 206, the OS may be loaded at block 210. Processing by the computing system continues by running the OS and application programs as is known in the art.

While the computing system is up and running, self-healing component 109 may be executed by one or more of the cores to detect and/or handle any runtime errors that occur in the processor semiconductor chip (e.g., a machine check) at block 208. In an embodiment, self-healing component may be run periodically, or may be executed only when an unrecoverable error occurs in a core. In an embodiment, when an error is detected that results in a failure of a core at block 210, self-healing component 109 updates the core configuration stored in processor configuration information (PCI) 110 in the NVRAM. For example, if a core has failed, self-healing component removes that core from the set of valid and operable cores and adds that failed core to the set of failed cores in the PCI. If a spare core is available, self-healing component adds the spare core to the set of valid and operable cores and removes the spare core from the set of spare cores. Since the core has failed, the processor semiconductor chip must be restarted using the updated processor configuration information (i.e., the computer system no longer will use the failed core but will use the spare core instead). In an embodiment, as part of the restart process, self-healing component may direct the one or more cores in the processor semiconductor chip to save any work-in-progress, if possible, being done by the one or more cores of the processor semiconductor chip. Processing then continues at block 202 to reset and reinitialize the processor semiconductor chip. In an embodiment, if there are virtual machines (VMs) or hypervisors running in the computing system that are paused as a result of the core failure, these programs may be resumed when the processor is rebooted. Thus, down time as a result of a failed core may be minimized.

In an embodiment, updating of the processor configuration information may be performed as a result of an action by a system administrator or by remote management of the computing system (i.e., on demand). For example, the processor semiconductor chip may be manufactured with a number of spare cores. At the time of sale or the processor and/or the computing system a predetermined first number of valid and operable cores may be enabled in the processor configuration information with a predetermined second number of cores held as spares. Later, when the processor is being used in a computing system, a user may desire that the computing system may use additional cores to increase the performance characteristics of the processor. In that case, the OS, for example, may instruct self-healing component 109 to move spare cores to the set of valid and operable cores. In an embodiment, providing added processing capacity by enabling spare cores may be performed for a fee. Because the processor configuration information and the self-healing component are stored in NVRAM, the capability to adjust the processing capacity of the processor may be flexible than known systems where the processor configuration information is hardwired in the processor circuitry.

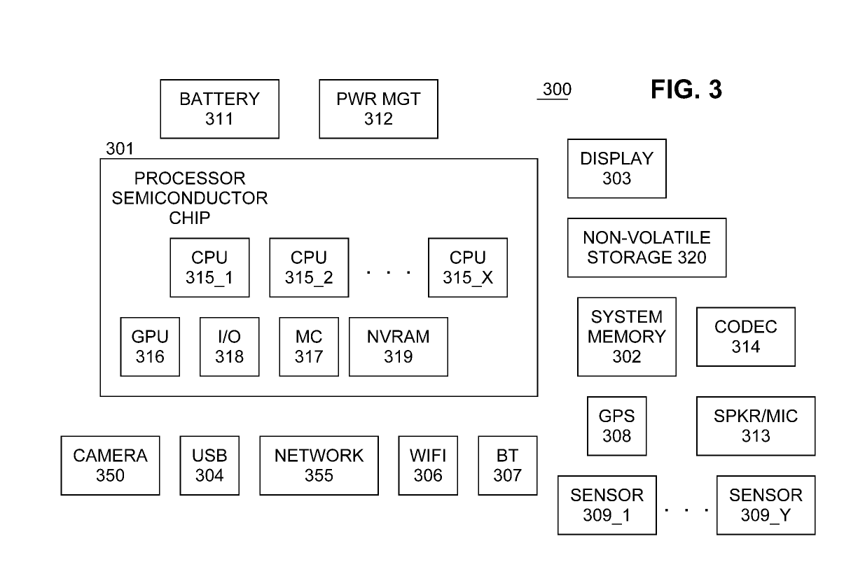

FIG. 3 illustrates an example computing system that can perform self-healing with embedded NVRAM on a processor semiconductor chip. According to some examples, computing system may include, but is not limited to, a server, a server array or server farm, a web server, a network server, an Internet server, a work station, a mini-computer, a main frame computer, a supercomputer, a network appliance, a web appliance, a distributed computing system, a personal computer, a tablet computer, a smart phone, multiprocessor systems, processor-based systems, or combination thereof

As observed in FIG. 3, the computing system 300 may include a processor semiconductor chip 301 (which may include, e.g., a plurality of general purpose processing cores 315_1 through 315_X) and a main memory controller (MC) 317 disposed on a multi-core processor or applications processor, system memory 302, a display 303 (e.g., touchscreen, flat-panel), a local wired point-to-point link (e.g., USB) interface 304, various network I/O functions 355 (such as an Ethernet interface and/or cellular modem subsystem), a wireless local area network (e.g., WiFi) interface 306, a wireless point-to-point link (e.g., Bluetooth (BT)) interface 307 and a Global Positioning System (GPS) interface 308, various sensors 309_1 through 309_Y, one or more cameras 350, a battery 311, a power management control unit (PWR MGT) 312, a speaker and microphone (SPKR/MIC) 313 and an audio coder/decoder (codec) 314. The power management control unit 312 generally controls the power consumption of the system 300.

An applications processor or multi-core processor 301 may include one or more general purpose processing cores 315 within processor semiconductor chip 301, one or more graphical processing units (GPUs) 316, a memory management function 317 (e.g., a memory controller (MC)) and an I/O control function 318. The general-purpose processing cores 315 execute the operating system and application software of the computing system. The graphics processing unit 316 executes graphics intensive functions to, e.g., generate graphics information that is presented on the display 303. The memory control function 317 interfaces with the system memory 302 to write/read data to/from system memory 302. The processor 301 may also include embedded NVRAM 319 as described above to improve overall operation of BIOS 106 and self-healing component 109 that executes on one or more of the CPU cores 315.

Each of the touchscreen display 303, the communication interfaces 304, 355, 306, 307, the GPS interface 308, the sensors 309, the camera(s) 310, and the speaker/microphone codec 313, and codec 314 all can be viewed as various forms of I/O (input and/or output) relative to the overall computing system including, where appropriate, an integrated peripheral device as well (e.g., the one or more cameras 310). Depending on implementation, various ones of these I/O components may be integrated on the applications processor/multi-core processor 301 or may be located off the die or outside the package of the applications processor/multi-core processor 301. The computing system also includes non-volatile storage 320 which may be the mass storage component of the system.

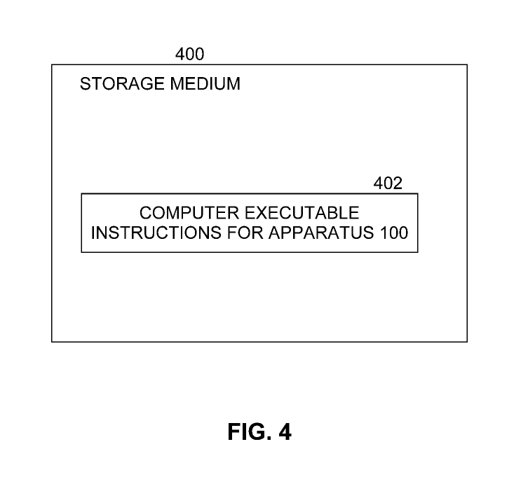

FIG. 4 illustrates an example of a first storage medium. As shown in FIG. 4, the first storage medium includes a storage medium 400. The storage medium 400 may comprise an article of manufacture. In some examples, storage medium 400 may include any non-transitory computer readable medium or machine readable medium, such as an optical, magnetic or semiconductor storage. Storage medium 400 may store various types of computer executable instructions, such as instructions to implement logic flows 200 and/or BIOS 106 and self-healing component 10. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A processor comprising:
one or more processing cores; and
an embedded non-volatile random-access memory (NVRAM) coupled to the one or more processing cores, the NVRAM storing instructions that when executed by the one or more processing cores update processor configuration information and cause reset and initialization of the processor using the updated processor configuration information.

2. The processor of claim 1, wherein the processor configuration information comprises one or more of a set of valid and operable cores, a set of failed cores, and a set of spare cores.

3. The processor of claim 2, comprising instructions to detect a core failure, and wherein instructions to update the processor configuration comprise instructions to update the processor configuration information that reflects the core failure.

4. The processor of claim 3, wherein instructions to update the processor configuration information comprise instructions to remove the failed core from the set of valid and operable cores and add the failed core to the set of failed cores.

5. The processor of claim 2, wherein instructions to update the processor configuration information comprise instructions to remove a spare core from the set of spare cores and add the spare core from the set of spare cores to the set of valid and operable cores.

6. The processor of claim 1, wherein the embedded NVRAM stores the processor configuration information.

7. The processor of claim 1, wherein the processor configuration information is stored in the NVRAM at time of manufacturing of the processor.

8. The processor of claim 1, wherein the NVRAM comprises a three-dimensional cross point memory.

9. A computing system, comprising:
a system memory;
a processor coupled to the main memory, the processor comprising:
one or more processing cores; and
an embedded non-volatile random-access memory (NVRAM) coupled to the one or more processing cores, the NVRAM storing instructions that when executed by the one or more processing cores update processor configuration information and cause reset and initialization of the processor using the updated processor configuration information.

10. The computing system of claim 1, wherein the processor configuration information comprises one or more of a set of valid and operable cores, a set of failed cores, and a set of spare cores.

11. The computing of claim 10, comprising instructions to detect a core failure, and wherein instructions to update the processor configuration comprise instructions to update the processor configuration information that reflects the core failure.

12. The computing system of claim 11, wherein instructions to update the processor configuration information comprise instructions to remove the failed core from the set of valid and operable cores and add the failed core to the set of failed cores.

13. The computing system of claim 10, wherein instructions to update the processor configuration information comprise instructions to remove a spare core from the set of spare cores and add the spare core from the set of spare cores to the set of valid and operable cores.

14. The computing system of claim 9, wherein the embedded NVRAM stores the processor configuration information.

15. The computing system of claim 9, wherein the processor configuration information is stored in the NVRAM at time of manufacturing of the processor.

16. The computing system of claim 9, wherein the NVRAM comprises a three-dimensional cross point memory.

17. A method comprising:
reading a self-healing component from a NVRAM embedded in a processor semiconductor chip having one or more processing cores;
executing the self-healing component by the one or more processing cores to detect an error causing a core failure, update processor configuration information that reflects the core failure, and cause reset and initialization of the processor semiconductor chip using the updated processor configuration information.

18. The method of claim 17, wherein the processor configuration information comprises one or more of a set of valid and operable cores, a set of failed cores, and a set of spare cores.

19. The method of claim 18, wherein updating the processor configuration information comprises removing the failed core from the set of valid and operable cores and adding the failed core to the set of failed cores.

20. The method of claim 18, wherein updating the processor configuration information comprises removing a spare core from the set of spare cores and adding the spare core from the set of spare cores to the set of valid and operable cores.

21. The method of claim 17, comprising reading processor configuration information from the NVRAM and storing updated processor configuration information into the NVRAM.
